(19) United States
(12) Patent Application Publication
(10) Pub. No.: US 2008/0296152 A1
(43) Pub. Date: Dec. 4, 2008

(54) Apparatus for generating electrical discharge

(76) Inventor: Axel Voss, Kreuzlingen (CH)

Correspondence Address: DAVID L. KING, SR., 5131 N.E. COUNTY ROAD 340, HIGH SPRINGS, FL, 32643, US

(21) Appl. No.: 11/724,130

(22) Filed: Mar. 14, 2007

Related U.S. Application Data
(60) Provisional application No. 60/743,514, filed on Mar. 17, 2006.

(30) Foreign Application Priority Data
Mar. 16, 2006 (DE) 10 2006 012 204.6

(51) Int. Cl. B01J 19/08

(52) U.S. Cl. 204/242; 204/293

(57) ABSTRACT

The invention relates to an apparatus (2) for generating electrical discharge in a fluid medium (3) in order to generate electrohydraulic shock waves. The electrodes (1) consist of a metallic work material. An electrical voltage is applied to the electrodes (1) in order to generate a voltage breakdown between the tips of the electrodes in the fluid medium (3), which work material consists of a titanium alloy with a hardness of at least 300 HV to 650 HV.

### STATEMENT OF RELATED CASES

Pursuant to 35 U.S.C. 119(a), the instant application claims priority to prior German application number 10 2006 012 204.6, filed Mar. 16, 2006. This application also claims the benefit of U.S. Provisional Application No. 60/743,514, filed Mar. 17, 2006.

The invention relates to an apparatus for generating electrical discharge in a fluid medium in order to generate electrohydraulic shock waves. The apparatus comprises electrodes consisting of a metallic work material. An electrical voltage is applied to the electrodes in order to generate a voltage breakdown between the tips of the electrodes in the fluid medium.

Shock wave generators are used in numerous medical fields.

The best-known field is the therapeutic and cosmetic application in the treatment for instance of calculous diseases (e.g. urolithiasis, cholelithiasis) and the treatment of scars in human and veterinary medicine.

New fields of application relate to dental treatment, the treatment of arthrosis, the ablation of calcium deposits (e.g. tendinosis calcarea), the treatment of chronic tennis or golfer elbows (so-called radial or ulnar epicondylopathy), of chronic discomfort of the shoulder tendons (so-called tendinosis of the rotator cuff), and of chronic irritation of the Achilles tendon (so-called achillodynia).

Furthermore, the generation of shock waves is used in the therapy of osteoporosis, periodontosis, non-healing bone fractures (so-called pseudoarthrosis), bone necroses, and similar diseases. Newer studies also investigate the application in stem cell therapy.

Furthermore, the generation of shock waves can be used to exert mechanical stress, e.g. in the form of shearing forces, on cells, during which their apoptosis is initiated. This happens for example by means of an initiation of the ‘death receptor pathway’ and/or the cytochrome c-pathway and/or a caspase cascade.

The term apoptosis is understood to refer to the initiation of a genetically controlled program which leads to the ‘cell suicide’ of individual cells in the tissue structure. As a result, the cells concerned and their organelles shrink and disintegrate into fragments, the so-called apoptotic bodies. These are phagocytized afterwards by macrophages and/or adjoining cells. Consequently, the apoptosis constitutes a non-necrotic cell death without inflammatory reaction.

Therefore, the application of shock waves is beneficial in all cases, where it relates to the treatment of diseases with a lowered rate of apoptosis, e.g. treatment of tumors or viral diseases.

Additionally, the generation of shock waves can be applied especially beneficially in the treatment of necrotically changed areas and structures in muscle tissue, especially in tissue of the cardiac muscle, in the stimulation of cartilage build-up in arthritic joint diseases, in the initiation of the differentiation of embryonic or adult stem cells in vivo and in vitro in relation to the surrounding cell structure, in the treatment of tissue weakness, especially of cellulitis, and in the degradation of adipose cells, as well as for the activation of growth factors, especially TGF-[beta].

Likewise, the generation of shock waves can be used for avoiding the formation and/or extension of edema, for the degradation of edema, for the treatment of ischemia, rheumatism, diseases of joints, jaw bone (periodontosis), cardiologic diseases and myocardial infarcts, pareses (paralyses), neuritis, paraplegia, arthrosis, arthritis, for the prophylaxis of scar formation, for the treatment of scar formation respectively nerve scarring, for the treatment of achillobursitis and other bone necroses.

Another application relates to the treatment of spinal cord and nerve lesions, for example, spinal cord lesions accompanied by the formation of edema.

Shock waves are also suitable for the treatment of scarred tendon and ligament tissue as well as of poorly healing open wounds.

Such poorly healing open wounds and boils are called ulcus or also ulceration. They are a destruction of the surface by tissue disintegration at the dermis and/or mucosa. Depending on what tissue parts are affected, superficial lesions are called exfoliation (only epidermis affected) or excoriation (epidermis and corium affected).

Open wounds that can be treated with shock waves comprise especially leg ulcers, hypertensive ulcers, varicose ulcers or terebrant ulcers on account of the resulting improved healing process.

Furthermore, shock waves are suitable for the stimulation of cell proliferation and the differentiation of stem cells.

In order to generate shock waves, metallic electrodes are used between which a voltage breakdown takes place by the application of an electrical voltage. The voltage breakdown causes a discharge that for its part generates a short, intensive shock-like pressure wave, a shock wave, in a fluid medium, e.g., water. The shock wave causes a tensile stress in its fluid effective range that produces cavitation bubbles in a regular, chaotic manner that then collapse. If the collapse of the cavitation bubbles takes place in the immediate vicinity of a solid body, this can tear out components of the body, which is desired in the case of a kidney stone. However, the destructive action of the cavitation bubbles also affects the metallic electrodes that are necessary for generating the shock waves.

In this connection the material hardness and the strength of the metallic work material from which the electrodes are manufactured, become more important. However, the harder the work material is and the greater the material strength is, the more difficult it also is to work the material for the manufacture of electrodes. Because the electrodes are used in a fluid medium the corrosion qualities of the material must also be considered. In addition to the strength features of the work material even the electrical qualities of the work material such as, e.g., the conductivity must also be pointed out here as a selection criterion of the work material. Since the electrodes are used in surgical instruments, they should also consist of a light material to the extent possible. Furthermore, the electrical voltage applied to the electrodes generates a high thermal load for the electrodes.

Therefore, it is desirable that a very strong material with high conductivity, good corrosion resistance, high thermal resistance and a low specific density is made available that can be readily worked.

A material is known from patent DE 101 12 462 C1 that is used for the manufacture of electrodes for an apparatus for generating electrohydraulic shock waves. This concerns here a non-ferrous alloy with components of cobalt, nickel and titanium. This alloy has a high thermal loading capacity and a good mechanical workability quality. The specific density of the electrodes is too high on account of the alloy components, cobalt and nickel, which constitutes a weight problem.

The invention therefore has the task of making an apparatus available for generating electrical discharges in a fluid medium for generating electrohydraulic shock waves, whose electrodes comprise a very strong material with high conductivity, good corrosion resistance, high thermal resistance and a good mechanical workability quality that has a low specific density.

The task is solved in accordance with the generic part of claim 1 in combination with its characterizing features starting from an apparatus for generating electrical discharge in a fluid medium for generating electrohydraulic shock waves.

The task is solved in accordance with the invention in that an apparatus for generating electrical discharge in a fluid medium for generating electrohydraulic shock waves comprises electrodes consisting of a metallic work material in which fluid medium an electrical voltage is applied to the electrodes for the purpose of generating a voltage breakdown between the tips of the electrodes and which metallic work material consists of a titanium alloy with a hardness of at least 300 HV to 650 HV.

The solution has the advantage that electrodes are made available for the apparatus that have a very strong material with a low specific density.

In a further preferred embodiment the metallic work material of the electrodes consists of a titanium alloy with a titanium component of 80% -94%.

In a further preferred embodiment the metallic work material of the electrodes consists of a titanium alloy with an aluminum component greater than 4%.

In a further preferred embodiment the metallic work material of the electrodes consists of a titanium alloy with a vanadium component greater than 2%.

In a further preferred embodiment the metallic work material of the electrodes consists of a titanium alloy with an iron component greater than 0.1%.

In a further preferred embodiment the metallic work material of the electrodes consists of the titanium alloy Ti-6A1-4V consisting of approximately 6% aluminum, 4% vanadium, 0.25% or less iron, 0.2% or less oxygen and 90% titanium. The density of Ti-6A1-4V is 4.43 g/cm³, that is far below the density of steel with 7.85 g/cm³. The hardness is 396 HV. The E modulus is approximately 114000 MPa at 20° C. The electrical resistance is 0.000178 Ω/cm. The thermal conductivity is 6.7 W/mK. The melting point is approximately 1604° C.

In a further preferred embodiment the metallic work material of the electrodes consists of the titanium alloy Ti-6A1-6V-2Sn consisting of approximately 6% aluminum, 6% vanadium, 2% tin and 86% titanium. The density of Ti-6A1-6V-2Sn is 4.54 g/cm³. The hardness is 430 HV. The E modulus is approximately 117000 MPa at 20° C. The electrical resistance is 0.000157 Ω/cm. The thermal conductivity is 6.6 W/mK. The melting point is approximately 1627° C.

The solution has the advantage that electrodes are made available for the apparatus that have a very strong material with high conductivity, good corrosion resistance, high thermal resistance and a good mechanical workability quality that has a low specific density.

The invention is explained in detail in the following using the drawing.

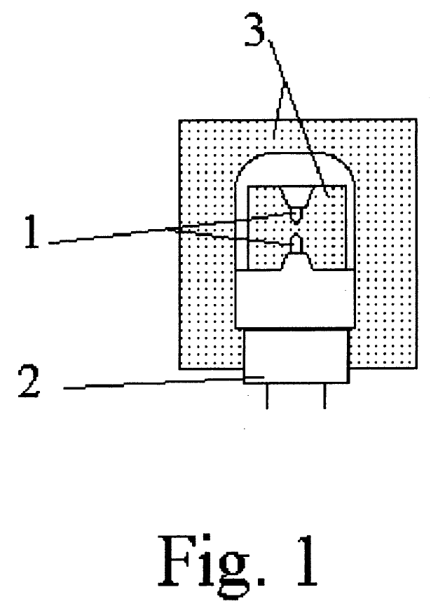

FIG. 1 shows a schematic view of an apparatus for generating electrical discharge in a fluid medium for generating electrohydraulic shock waves with electrodes.

FIG. 1 shows an apparatus (2) for generating electrical discharge in a fluid medium (3) for generating electrohydraulic shock waves by means of electrodes (1).

In order to produce shock waves, the metallic electrodes (1) are used, between which a voltage breakdown takes place by the application of an electrical voltage. The electrical voltage causes a discharge that for its part generates a short, intensive shock wave in the fluid medium (3), e.g., water, which shock wave is used in medicine, e.g., for the removal of kidney stones.

The discharge of the electrical voltage in the fluid medium (3) has a destructive action on the metallic electrodes (1). The greater the material strength of the electrodes (1) is, the less the destructive action of the discharges.

According to the invention a metallic work material with a very hard titanium alloy is selected for the electrodes (1).

The solution has the advantage that electrodes (1) are made available for the apparatus (2) that have a very strong material with a low specific density.

1. Apparatus (2) for generating electrical discharge in a fluid medium (3) for generating electrohydraulic shock waves, with electrodes (1) consisting of a metallic work material in which fluid medium (3) an electrical voltage can be applied to the electrodes (1) for the purpose of generating a voltage breakdown between the tips of the electrodes (1), characterized in that the metallic work material consists of a titanium alloy with a hardness of at least 300 HV to 650 HV.

2. Apparatus according to claim 1, in which the titanium alloy has a titanium component of 80%-94%.

3. Apparatus according to claim 1 or 2, in which the titanium alloy has an aluminum component greater than 4%.

4. Apparatus according to one of claims 1-3, in which the titanium alloy has a vanadium component greater than 2%.

5. Apparatus according to one of claims 1-4, in which the titanium alloy has an iron component greater than 0.1%.

6. Apparatus according to one of claims 1-5, in which the titanium alloy has a tin component greater than 1%.

7. Apparatus according to claims 1-5, in which the aluminum component is 6%, the vanadium component 4%, the iron component 0.25% or less, the oxygen component 0.2% or less and the titanium component 90%.

8. Apparatus according to claims 1, 2, 3, 4 and 6, in which the aluminum component is 6%, the vanadium component 6%, the tin component 2% and the titanium component 86%.

9. Electrode (1) for use in an apparatus (2) in accordance with one of the previous claims.
